(19) United States
(12) Patent Application Publication
(10) Pub. No.: US 2015/0302475 A1
(43) Pub. Date: Oct. 22, 2015

(54) MANAGING, PUBLISHING AND TRACKING CONTENT FOR VIRTUAL STORE DISPLAY WINDOWS

(71) Applicants: Sujit Thomas Zachariah, Bangalore (IN); Rakesh Raghuvanshi, Mumbai (IN); Mohit Talwadiya, Bangalore (IN)

(72) Inventors: Sujit Thomas Zachariah, Bangalore (IN); Rakesh Raghuvanshi, Mumbai (IN); Mohit Talwadiya, Bangalore (IN)

(21) Appl. No.: 14/548,011

(22) Filed: Nov. 19, 2014

Related U.S. Application Data
(60) Provisional application No. 61/906,502, filed on Nov. 20, 2013.

(51) Int. Cl. G06Q 30/02; G06Q 30/06

(52) U.S. Cl. CPC G06Q 30/0256; G06Q 30/0259; G06Q 30/0267; G06Q 30/0619

(57) ABSTRACT

In one aspect, method includes the step of receiving a request from a third-party website for information about a brand promoter. Another step includes receiving a context-based promotion from the brand promoter. Another step includes matching the context-based promotion with the context teen based on a similarity of the context term with the context-based promotion. Another step includes obtaining the context-based promotion from a context-based promotion database. Another step includes formatting the context-based promotion for display with a search result page of the third-party website, wherein the search result page comprises one or more listings of entities associated with the search key term. Another step includes instructing the third-party website to integrate the context-based promotion into a listing of a brand entity associated with the brand promoter on the search result page of the third-party website.

### CROSS-REFERENCE TO RELATED APPLICATIONS

This application is a claims priority from U.S. Provisional Application No, 61/906,502, titled A PLATFORM FOR MANAGING, PUBLISHING AND TRACKING CONTENT FOR VIRTUAL STORE DISPLAY WINDOWS and filed 20 Nov. 2013. This application is hereby incorporated by reference in its entirety.

### FIELD OF THE INVENTION

The invention is in the field of digitally influenced commerce and more specifically to a method, system and apparatus of managing, publishing and tracking content for virtual store display windows.

### DESCRIPTION OF THE RELATED ART

Currently, smart phones and other devices with web based capabilities (browser based, application based or messaging based), including navigational devices are used apart from desktops/laptops to search and find items/places of interest by individuals, often in their local vicinity. There are also multiple advertising methods which allow products to be showcased on the web. These show up on web pages during web browsing by the individual consumer. These applications may also use the current customer or user location information to provide location specific information to help customer make his decisions.

However, the functionality of these web based advertisements and applications suffer from the fact that these depend on the customer being able to locate a specific brand among the large number of responses received during a search. Further any ad shown is only effective in capturing the customer only if the customer is interested in the ad being shown on the website and decides to interact with it. As a result, ads are often ignored by users (“advertising blindness”). None of these current ads seem to provide the impact of the regular store window display 100, shown in FIG. 1, typically embedded directly in store related content online, enabling window shopping and influencing that exist in real time, to bring in feet (customer traffic) in the door of the local businesses.

The current web based advertisement does not also provide active data feed back to the advertisers of the performance of items displayed available in specific store locations or live impact of any discounts and promotions at specific store locations.

It will be ideal if a system and method to bring in customer traffic in the door of digital stores can be devised that replicate the functions and capabilities of the store window of local stores. It would be of further advantage if the local store management and the brand management are able to review the feedback data from the stores and determine impact of specific promotions and modify these to optimize the impact in real time

### BRIEF SUMMARY OF THE INVENTION

In one aspect, a digital window for a contextual content is a digital store front window. A server system for receiving content inputs from brand promoters and local stores is provided. The server system includes, at least, the following; a processor, a database; a communication interface; and a storage memory; the server system enabled to automatically generate location specific rich media displays using the content input from a brand promoter, that are modified by a content input from a local store of a specific location; the server system compiling the rich media advertisements for display on the digital store front window; the digital store front window enabled for displaying the generated rich media content on multiple mobile and non-mobile type display platforms; the digital store front window further enabled to transmit a generated location specific rich media advertisements to display units in each specified location for display on their specific platforms; the location specific content on the digital store window thereby impacting both on-line purchasing by a first group of customers, and local in-store purchasing by a second group of customers; wherein the first group of customers is enabled to get information on the product or service, over the digital window, regarding, quality, pricing, availability, sales, vouchers, customer reviews of the product, and other characteristics and attributes of importance to enable them to make on-line purchase decisions; and wherein the second group of customers are enabled to identify the local store with product or service availability, in addition to being enabled to get information on the product or service, over the digital window, regarding quality, pricing, availability, sales, vouchers, customer reviews of the product, and other characteristics and attributes of importance to enable them to walk into the local store and make in-store purchase decisions.

In another aspect, a method includes the step of receiving a request from a third-party website for information about a brand promoter, wherein the request comprises a search key term, and wherein the search query comprises a search key term used to identify a context term, wherein the context term describes a context of a user's access to the third-party website and a user's geographical location. Another step includes receiving a context-based promotion from the brand promoter. Another step includes matching the context-based promotion with the context term based on as similarity of the context term with the context-based promotion. Another step includes obtaining the context-based promotion from a context-based promotion database. Another step includes formatting the context-based promotion for display with a search result page of the third-party website, wherein the search result page comprises one or more listings of entities associated with the search key term. Another step includes instructing the third-party website to integrate the context-based promotion into a listing of a brand entity associated with the brand promoter on the search result page of the third-party website.

### BRIEF DESCRIPTION OF THE DRAWINGS

The present application can be best understood by reference to the following description taken in conjunction with the accompanying figures, in which like parts may be referred to by like numerals.

FIG. 1 illustrates a prior art system for delivering content and influencing consumers by window display in real time (Prior art).

FIG. 2 illustrates a through digital window display on a mobile device showing use of digital coupon in store by a shopper as per the disclosed in some embodiments

FIG. 3 illustrates the capabilities of the digital window display in some embodiments.

FIG. 4 illustrates the sample groups/channels of online destinations and mobile applications that in some embodiments has impact on due to delivery through various digital delivery media.

FIG. 5 illustrates the impact of the brand advertisement in window on consumers, stores and products.

FIG. 6 is an exemplary block diagram of a system implementing some embodiments.

FIG. 6A is a more detailed block diagram showing the operational linkage and details and relating it to the server system.

FIG. 7 is an exemplary flow chart of the development, publishing, management, display and tracking of the digital store window with brand content modified to for store locations for location specific display an identified display platform.

FIG. 8 is an exemplary flow chart showing the near real time modification capability of the system to provide response to customer queries on product and services or other store related content over the digital store window display.

FIG. 9 illustrates an example process, according to some embodiments.

The Figures described above are a representative set, and are not an exhaustive with respect to embodying the invention.

### DESCRIPTION

Disclosed are a system, method, and article of managing, publishing and tracking content for virtual store display windows. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth, in other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Digital store front (e.g. cyber storefront, electronic storefront, e-storefront, online storefront, virtual storefront, etc.) can be a website that offers goods and/or services for sale, and which the customers (e.g. the metaphorical ‘window shoppers’) can visit.

Rich media can include digital media (e.g. interactive digital media) that exhibit dynamic motion, taking advantage of enhanced sensory features such as video, audio and animation.

### Exemplary Methods and Systems

A method implemented on a server system for increasing effectiveness of influencing consumers by using free-form display, similar to off-line store window, such as digital store window is disclosed. The advertisers are enabled to influence digital-foot-fall (customers) on one or more digital-streets (publisher sites) using dynamic rich-media content distribution. The content is automatically generated and modified from multiple input content types, in near real-dine, for display on any type of display platform. Some embodiments enable modification of the displayed content to include location and store specific information for on-line and in-store last mile customer purchase decisions. The server system capability provides the brand management and publishers the capability to monitor the impact of the content by collection and compilation of data in near real time. Data analytics is also enabled by the server system handling the operations.

In the description, certain terminology is used to describe features of some embodiments. For example, in certain situations, the terms “display” advertisement (ad),”, “store”, “business”, “component,” “unit,” “module,” etc. are all representative terminology used to describe and perform one or more functions. For instance, examples of “hardware” used to implement the system include, but are not limited or restricted to an integrated circuit such as a processor (e.g., a digital signal processor, microprocessor, application specific integrated circuit, a micro-controller, etc.). Terminology such as “digital window server”, “window server” or “server” are all referring to the “server” and may be used interchangeably in the specification without further definition. Of course, the hardware may be alternatively implemented as a finite state machine or even combinatorial logic. An example of “software” includes executable code in the form of an application, an applet, a routine or even a series of instructions. The software may be stored in any type of machine-readable medium. Stores and local businesses include physical outlets and service oriented businesses. Similarly, any content or advertisement (ad) may include static, dynamic, or rich media versions such video and other mobile ads.

Some embodiments provide the advertiser with the ability to influence digital foot fall (customers) on one or more digital streets (publisher sites) using dynamic and live content distribution that is automatically generated and modified from all available input content types, in near real time, for display over all types of display platforms used by the customers. Some embodiments further provide for automatic generation of rich media digital content for display in free-form, similar to offline store window. In particular, it enables content publishing to multiple sites without needing the help of software/web developers. Some embodiments also provide the capability to modify the displayed ad to include store location specific information to enable both on-line and in-store last mile purchase decisions.

Some embodiments provide a digital window similar in form to the store window of the local stores. In its basic form, virtual display windows refer to free form, fixed sized spaces that brands or store owners can upload content to at any time (preferably in real-time) with content (typically in rich format) that he/she deems best to influence and attract consumers who are considering/evaluating visiting the store on first party sites (e.g. owned website) or popular online destinations (e.g. internet yellow pages), social networks and mobile applications. The window display is generated from the inputs provided by store representative and the creativity is left to such inputs (and not constrained by the layouts such as listing data on internet yellow pages). Store representatives can provide specific inputs such as discounts and sales information, events, product promotions or store/product views from the local stores. Further, a variety of interfaces can be used for providing such inputs can be used by the store representatives (e.g. via the platform's web/mobile interface, via platform's mobile applications or Short Message Service (SMS) text messaging. Depending on the identified location of the user access, for example from a mobile device, the information on the window generation is adjusted to include local sales information in the window provided to the mobile device). As the user context moves from one store location to another the display is modified to suit the store. The digital display window also provides the consumer the ability to search in the local stores for items of the consumer's choice. If a search is identified the store window of the local store where such an item is available is shown on the display with any alternate products and location of the store. This provides the consumer with multiple choices of ordering on line with available discounts, or walking into the store to check out the item, enhancing the sales at the local store.

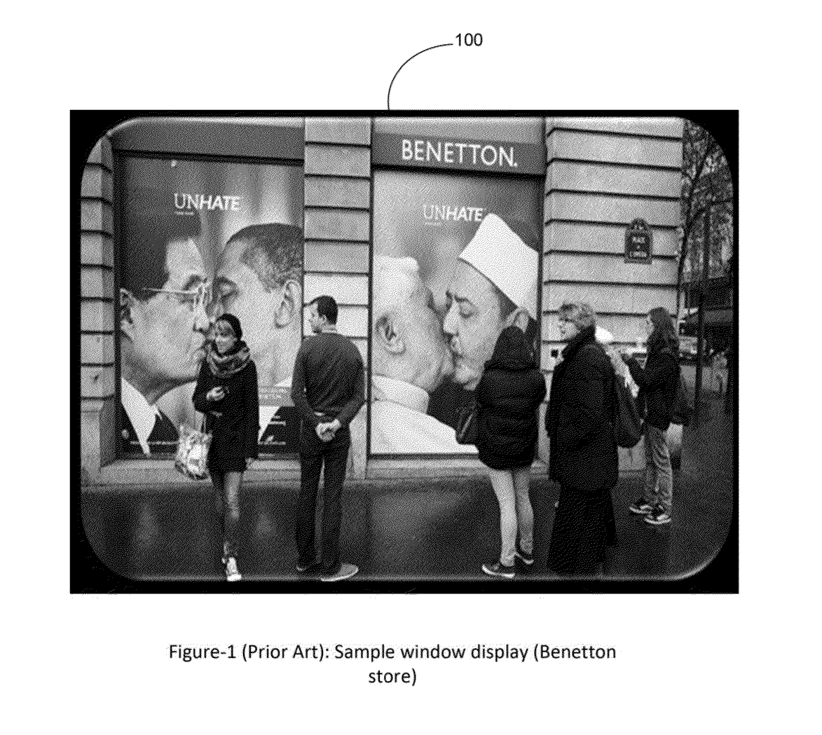

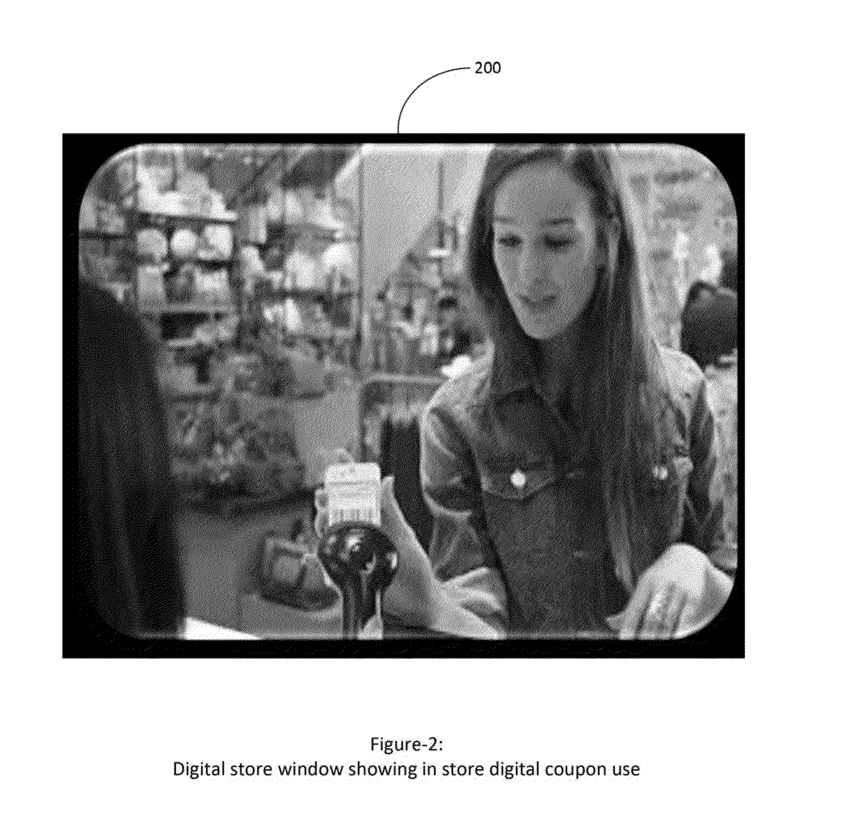

FIG. 1 illustrates a prior art system for delivering content and influencing consumers by window display in real time. FIG. 2 illustrates a digital window display 200 showing a consumer using a digital coupon during payment for goods as per one embodiment.

The question that should be asked by the local stores and brand is how to improve the brand visibility and local store visibility when customers are browsing on the go or searching for items on the web using the consumer's mobile or stationary computing devices. In most cases results of a search is displayed in the form of a number of text lines indicating the URL of web pages of stores or locations, which the consumer has to click and go through and check. The customer's checking of the web page is generally a sequential process which eliminates the brands and stores that have their URLs further down in the web page. This typically includes the local stores as large brands get priority on the web page for brand specific searches.

As is well known, browser based and mobile application based searches are becoming more and more attractive to shoppers. Since mobile devices are growing faster than other types of computing and communication devices, consumers are using on line more and more to find content and perform research about store locations and products/service on the mobile devices. Looking at the way shopping related content is identified and accessed on line provides a clue to consumer's preferences. Content is increasingly being accessed via search engines and social networks, especially in mobile devices It is very evident that the customers are searching across multiple digital personas and the mobile and performance marketing is disrupting shopping on high street. Some embodiments can connect the brands with customers over digital means as they are making purchase decisions (last mile) and influence them through digital contextual content including local content.

The disclosed digital window (technology) is able to interact with consumers as they make purchase decisions and provide then the necessary contextual content and incentive to make their decisions. It provides the customer with information on the brand and the available locations in the vicinity with sales and discounts, in addition to enabling online shopping capability.

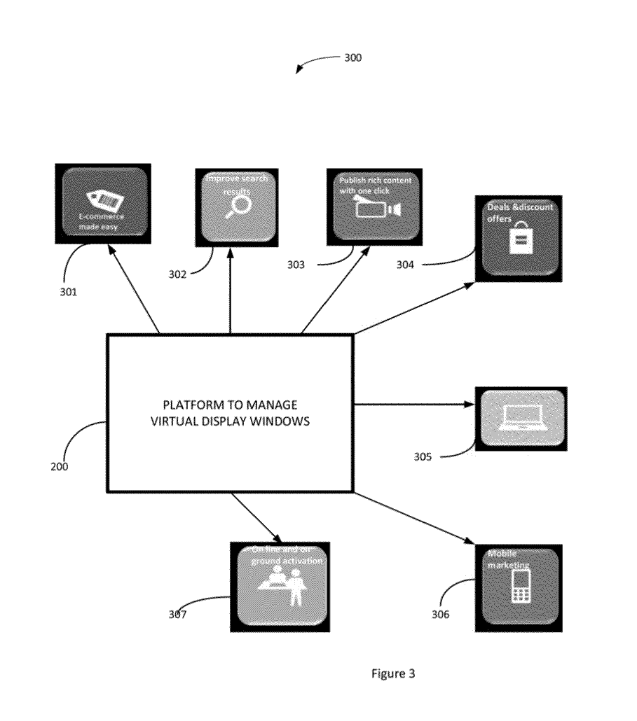

The digital window is enabled by a digital window server (server). FIG. 3 is a block diagram 300 illustrating the capabilities provided by the disclosed digital window system to help the brand and local stores to bring in customers and improve profitability. This is done by providing brand information and advertised promotions from the local stores directly to the customer in the neighborhood. As shown in the capability block diagram 300, the digital window system is able to provide much more than what a digital ad can. These are shown in the blocks of the block diagram 300 of the window system. The advantages provided include: a) With richer content that is updated more frequently on brand related pages across sites, the digital window system enable the brands to get ranked higher on the search engines and search directories there by driving more new customers to the brand 302. b) The digital window system is able to pull and publish the brand's earned and paid content across multiple digital apps from one set of creative and through a single platform 303. The window is able to generate and provide displays on social and local directories and web sites with a few clicks. c) The use of the digital window system, by virtue of its capability to identify and fix proximity and location of the mobile devices is able to provide to the appropriate customers any deals that the local store or national brands develop 304 in an expedited fashion through multiple communication means. This helps to drive customer traffic to the local store and to the enable the brand's digital site. d) The digital widow system enable the brands and stores to connect to existing customers directly by email, social media, SMS and mobile apps with a single button to inform them of any new promotions and discount deals to drive sales 305. e) The ability to know who is in the neighborhood of a store and who is searching for a product is also used to drive customers to the brand 306. f) The digital window system also provides the capability to enhance customer activation on hue and on ground by enabling efficient running of campaigns and promotions that are prominently displayed on the window 307. f) The use of the digital window system enables the brand exposure in software/ecommerce sites to drive the softer aspects of the brand which could not be exposed to the consumer in a standard advertisement 301. This can be done by providing access to more than the basic ad in the window and also by enabling store views that provide additional information and displays within the stores.

As discussed earlier, the digital window system provides the brand to develop strategy and tactics to drive last mile connection capability. To get store reach it is necessary to determine role of local marketing in national strategy by integrating the last mile. Development of local websites by automated content modification capability is an advantage that is provided by the digital window system. Use of local web media channels and other digital personas in the vertical and ecommerce help to reach consumers locally and drive traffic to local stores. The window system also enables measurement of impact of the local and brand provided content using digital personas to drive local marketing to learn, modify and increase marketing ROI. This can be done through the use of content, with local discounts displayed through earned, paid, owned and shared media. The measurements allow the brand and local stores to determine the impact of the ads and modify the ads on line to maximize the impact of displays and discounts.

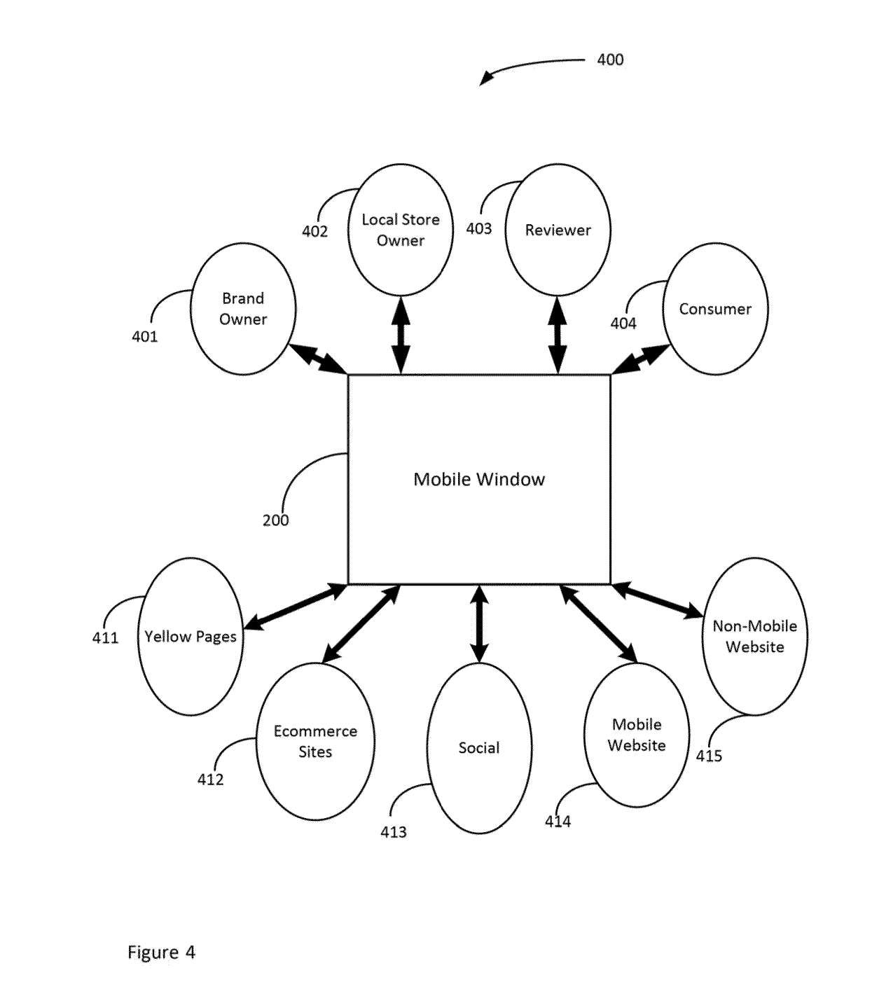

FIG. 4, is a block diagram showing the various groups 401 to 404 who provide inputs and get returns from the use of the digital window system. The groups include the brand owner 401 who inputs the information regarding the brand that is to be displayed on the digital window. The brand owner 401 also provides the brand level incentives and sales information that get incorporated directly into the window display. He in turn receives the measurements of the impact of the window content and any incentive or discounts provided as part of the sales program. The local store owners 402 are able to provide their inputs into the localized digital window display on locally identified digital communication units by adding the location address, any special discounts and coupons provided by the stores etc. The store as well as the brand owner can follow the added impact of these local incentives provided in bringing in feet to the stores. The incentives that are effective in the locality can then be provided at nearby stores to get improved product sales. Currently there are multiple review groups 403 such as bloggers, local/national newspapers and review magazines/sites generate independent store/product reviews. These reviews are used by the consumers to judge the quality of product and where to purchase it from as they approach the purchase decision. Positive reviews by such independent reviewers can be highlighted via the window display to promote businesses and/or its products and services. Finally the group of customers or consumers 404 often share elements of their actual buying experiences as reviews, feedback and/or shared photos. Such content can also be selectively used by brand/store representatives via window displays to positively influence consumers when researching, online or on the go.

FIG. 4 also shows the various mobile and non-mobile platforms that are used to display the digital window to the customers. The digital window provides a wide range of connectivity through yellow pages 411, ecommerce sites 412, social media sites 413 such as Twitter, Face-book, Google+ etc., location based services such as Foursquare, mobile websites 414 on cell phones, pads etc., and non-mobile web sites 415 on desk top computers and TV screens. The aim of the digital window system is to be a single provider of all content that can help influence consumers and enable more extensive research to all available digital communication media and to provide locally modifiable brand display as a digital window display to customers.

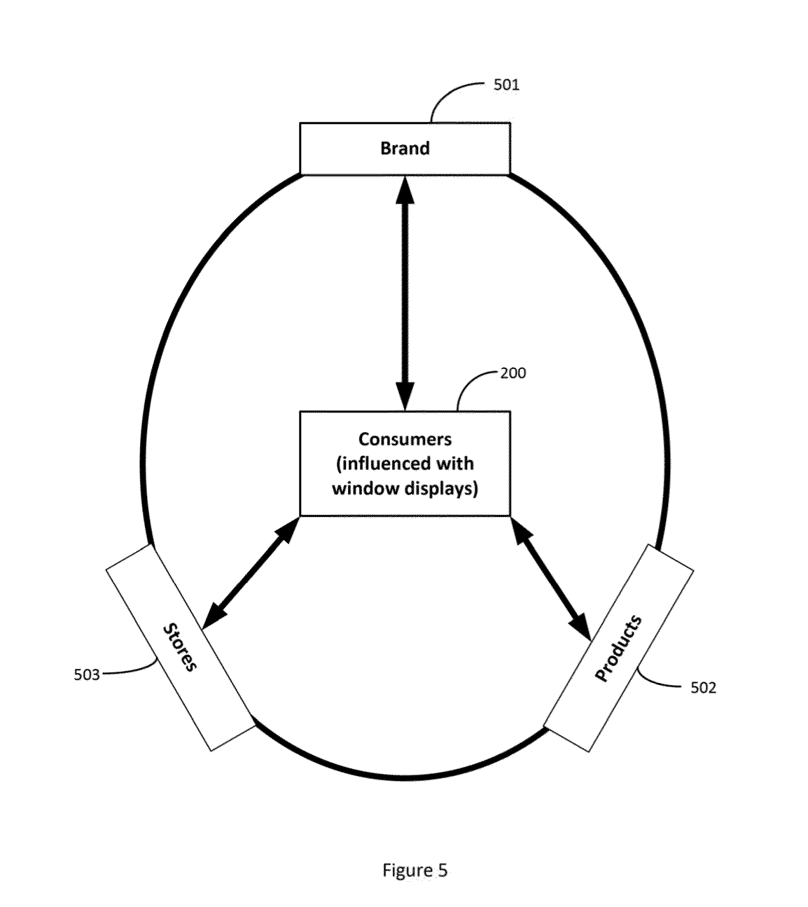

FIG. 5 is a block representation 500 showing the impact of the digital widow system displaying the brand content. It has been proposed by advertising gurus that it will be useful to provide content directly to consumers that adds value and facilitates conversation. Brand advertisers have been looking for a digital widget that can distribute product information to discussion forums; social media sites and product recommendation sites in addition to standard web sites in mobile and non-mobile devices. The digital window system provides this facility. The information that impacts the product 501, such as price, quality, availability, sales and vouchers etc. are provided on the digital window 200 over all available displays, on web sites, social media sites, mobile app sites etc. The consumer 502 is able to use the digital window 200 to review the product, check the reviews, find out about sales and vouchers at local stores and from brand content, decide on on-line or local purchase, and find the location of store near the location of the customer. The store owner 503 is able o use the digital window to have his or her store listed accurately at business sites, as the brand and also as the local store enabling the customer in and around the location of the store to access information on local sales, print coupons, events, product promotions and find the address/contact information to walk in if necessary. The store information is provided over the digital window to social media web sites, mobile websites and ecommerce sites over a pre-defined local coverage area to enable walk-in purchase by individuals who prefer that to on-line shopping.

In summary the items covered by the application include:

A) The virtual display windows with the following abilities and attributes.

Ability to influence “digital footfall” (consumers) on one or more “digital streets” (publishers) using live content distribution over: First party sites (owned website for example), third party publisher partner sites and applications (internet yellow pages, mobile applications, location based services, vertical sites, local search engines, social networks, etc.),

In free-form, digital content space similar to offline store window, content is aligned to the fixed real estate/layout space and size as determined by each individual publisher partner). The delivered content type on these usually comprise rich formats (images, videos, HTML code), but could be text only as well.

The display itself is populated by content either from a) brand. (chain) owner/manager (or representatives such as agencies), store (outlet) owner/manager (or representatives such as employee delegates), and/or reviewers of consumers or any other similar third party.

Support, for various incoming content types and associated channels, are handled by the server s stem. They include: text (e.g. text messaging from verified phone number), images (e.g. click and publish from provided mobile application). Video (e.g. uploaded via platform portal), html widgets (e.g. coupon distribution, today's specials, hooking an appointment, make an enquiry, etc.), or any combination of these types.

The system provides automatic transformation of content from incoming type (e.g. text message) to rich, visual object ready for delivery via virtual display window. It provides intelligent structuring and handling of multiple related messages to populate a single window message and other relevant attributes e.g. title, description, start date & time, end date & time). The digital server system also enables near real-time communications from store to consumers (in seconds-near real-time), to answer queries and provide updates, fix appointments etc.

The server system provides for dynamic, relevant contextual content to be delivered in real time based on context (business), user location, time of day and user intent—content displaying on such pages is no longer static even if the original content input is static. The content so convened and used is front context available from publisher to serving platform through: structured query from publisher to advanced learning or computation), or structured data extraction via crawling (offline advanced computation). The user intent can be any of: current (keywords or category used in search) or search/view history, including across brands and publishers.

B) Structuring data and interaction of product/service/menu information.

As described before, the current art to display product/services information (e.g. menus) is to provided scanned versions of product listings or to list all products and service offerings as a single list with pagination (multiple pages) if space on the publishers web page is limited. Further the order of the items shown is independent of what the user is looking for (e.g. pizza versus pasta). Alternately the result can be presented grouped by product category or product attributes (e.g. vegetarian).

What is proposed by the current disclosure is the ability to effectively organize and present information on product and service catalogue (e.g. menus) of information regarding a single or multi-location business effectively. The information itself is organized in a richer fashion (e.g. as images, structured attributes, availability status, offers etc.) to provide a more engaging customer experience, thereby generating more views and actions from the customers.

The information itself will be organized hierarchically (by category or the time and date of addition or modification etc.). This enables separate server side tracking of each category of products and service, by level of customer interest and action (e.g. click or play video and/or respond in alternate ways provided).

Due to the way the data tracking is organized the system is able to provide aggregate counts for category of product and service (with optionally select attributes) level views and actions by geo-regions of the country (locations) and even by time of the day. This helps businesses as a proxy for demand and hence useful for location wise inventory planning. The system is also able to generate and provide insights such as popular searches and missed opportunities (keywords searched by user in catalog but those that generated zero results).

The system is configured as a single platform that integrates with multiple publishers, (e.g. at different locations) such that updates from one place automatically refreshes content across distributed digital personas (if applicable to the specific location), providing an integrated display and viewing experience.

C) Monitoring store and product interactions and feedback using digital all tracking and/or recording.

The server system (that may include one server or multiple connected servers) also provides a set of central communication means on the digital window for communication to the brand and to local stores. By handling all the incoming and outgoing communication via the server system enables the brand managers to turn on or off call tracking, and call monitoring with recording of all brand related calls to owned-and-operated, franchised and local dealer outlets, resulting from business advertising in the digital window with display and listing on search sites and mobile application. When the communication monitoring is turned on, then each local store location can be assigned multiple virtual call numbers and mail ids that are then shown on the local digital window across all publishers. With multiple call numbers if individual numbers are allocated to each publisher then the calls are trackable by each publisher. The use of call in numbers assigned through the server system in the digital window system it is possible to generate analytics on calls by location/store and by time of day to understand the impact pattern of the digital window display. If recording is used on calls it is necessary to have announcement of intent to the caller at the start of the call to take care of privacy issues. By having the call recording turned on, the brand manager or his authorized associates can remotely from their office, monitor feedback and response to ads and launches of new product as well as interact with the local store in real time to provide suitable responses and take action on requests by customers. Since the communication monitoring is from the server end it is possible to turn on or off monitoring for one store, multiple stores in a location, multiple locations or all locations as needed from the single available platform. This allows test marketing of products, and services at a single or multiple locations without impacting the brand sales as a whole. Further with built in transcript capabilities and data mining based on transcripts, key themes/insights can be extracted and garnered for brand representatives and help save them for having to regularly listen into all recorded calls.

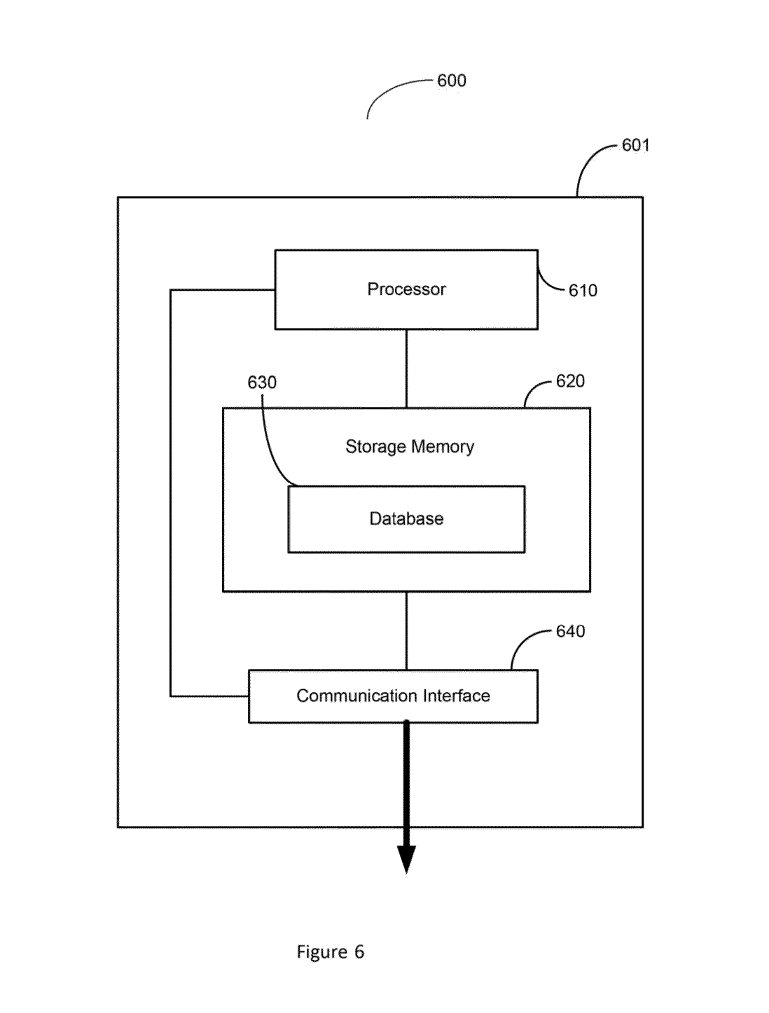

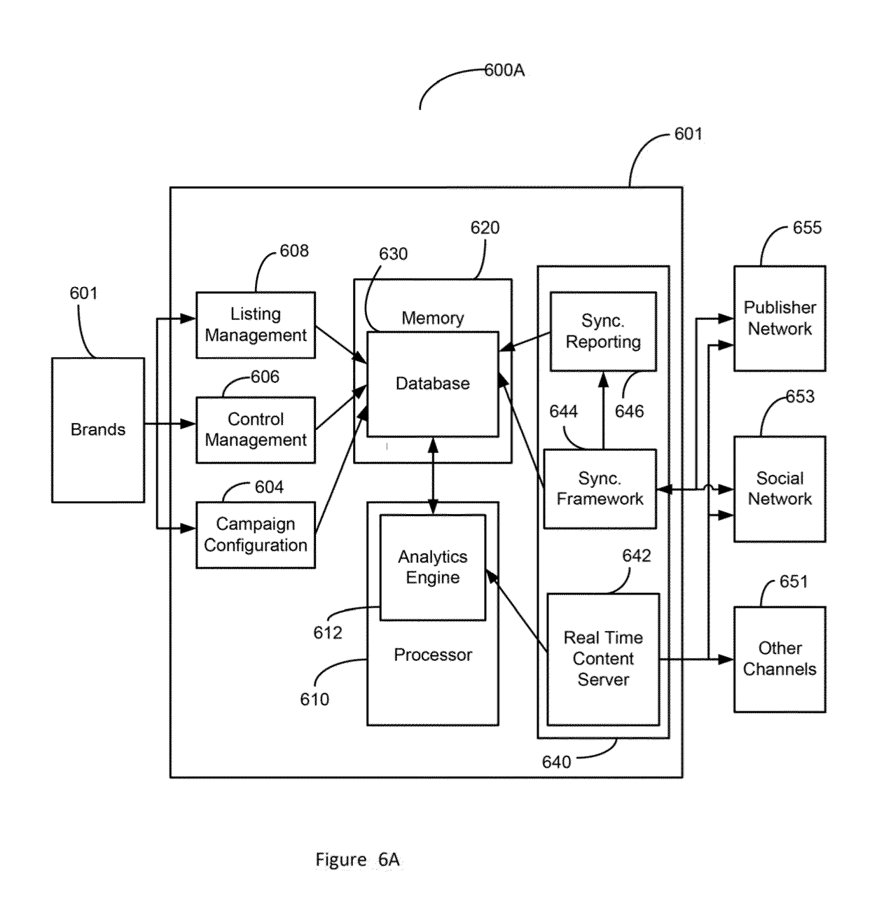

FIG. 6 illustrates exemplary components of a server system 600 implementing some embodiments. The server system 600 includes a server 601 that may include a processor 610, memory storage 620, and a communication interface 640.

The communication interface 640 is a network communication interface that may include a wired network interface such as an IEEE 802.3 Ethernet interface as well as a wireless interface such as an IEEE 802.11 WiFi interface. Data may also be received from any one of a variety of different wireless communications networks and in accordance with any one of several different protocols. These include: a cellular mobile phone network (e.g. a Global System for Mobile communications, GSM, network), including current 2G, 3G, 4G, and LTE networks and an IEEE 802.11 network (WiFi or Wireless Local Area Network, WLAN). In one embodiment, the communication interface 640 may receive location data and proximity information from the mobile devices. The location data received from a mobile device may include the location and identification of the device and information on the devices that exist in its proximity. The communication interface 640 may also transmit the main digital display window and include any local variants for the window, including incentives and coupon information available within the store to the mobile devices identified. The processor 610 will provide the details and updates to be displayed in the window on the web screen, for transmission to the display devices near any location identified.

The processor 610 that is coupled to the communication interface 640 may include a microprocessor, a microcontroller, a digital signal processor, or a central processing unit, and other needed integrated circuits such as glue logic. The term “processor” may refer to a device having two or more processing units or elements, e.g. a CPU with multiple processing cores. The processor 640 may be used to control the operations of the communication interface 640. For example, the processor 640 may be coupled to the communication interface 640 and executes software to control the wireless network communications functionality of the system 600 (e.g. communicating with a network to transmit and receive data to other components of display system (e.g., mobile devices) via the communication interface 640). In some cases, a particular function may be implemented as two or more pieces of software that are being executed by different hardware units of a processor.

In one embodiment, the processor 610 is also coupled to the memory storage 620 that may include one or more different types of storage such as hard disk drive storage, nonvolatile memory, and volatile memory such as dynamic random access memory. The memory storage 620 may also include a database 630 that stores location data associated with the plurality of mobile devices included in system. The database 630 may also store membership information for loyalty groups, including member or mobile device characteristics, location identification, other location related information. The memory device 620 may also store instructions e.g. software; firmware), which may he executed by the processor 610. In one embodiment, when the instructions stored in memory device 620 are executed by the processor 610, the processor 610 performs methods for generating storefront information based on the advertisers input and local store inputs for location based digital storefront display. In some embodiments, the processor 610 may receive the location data and the proximity information from the communication interface, as well as immediate search information form mobile devices and provide location relevant storefront ads to the appropriate mobile devices. The processor 610 may also control the functions of the communication interface 640 by signaling to the communication interface 640 to request from each of the mobile devices in the system 600 their location data and proximity information as well as current search information. The server 601 will then use the communication interface 640 to transmit the appropriate store location and storefront, with discounts to be displayed on the mobile device.

In addition, various other peripheral units (not shown) may be connected to the server 601 to form a computer platform, such as but not limited to keyboards, mouse, additional data storage units, printing units and/or display units. The processor 610, memory storage 620, and communication interface 640 communicate to input devices and output devices via one or more communication links such as a bus. The communication links may also be other wired or wireless communication links. Though in FIG. 6, a single server 601 is shown, it is understood that the server 601 may be a virtual machine, with all the above capabilities, distributed over multiple servers or enabled in the cloud computing structure.

The embodiments may be described as a process, which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a procedure, etc.

FIG. 6A is a more detailed block diagram 600A showing the operational linkage and details and relating it to the server system 600. The brands 601 (advertisers) provide the server system 600 with the details of campaign configuration 604, advertisement control management details 606 and list management 608, these specify the what, where and how of the window display content. The input details are stored in the database 630 in the memory 620 of the sever 601. The brand input block shown also includes some real time inputs provided by stores in various geographic locations. The processor 610 uses these real time and stored inputs to automatically generate the window displays that are location/store specific for display as a digital store display. These location specific generated displays are provided to the display units that are identified to be in the vicinity of the stores, by a real time content server 642 that is part of the con module 640 of the server system 600. The real time content server 642 is coupled to an analytics engine 612 that is part of the processor 610. The analytics engine 612 keeps a log of the activities with time stamps and uses the power of the processor 610 to generate reports and analysis for the advertisers and publishers of the activities. The real time content server 642 working with the processor 610 and using its power is enabled to provide content in formats suitable for the various types of display channels, such as publisher network 655, social network 653 and other channels like web sites 651. Some data such as store listing data (name, address, phone number and similar attributes) can also be kept in sync with the publishers through offline sync framework 644 with supporting storage in database 630. Sync status reporting to brand advertisers and publishers are enabled using a sync reporting block 646. The analytics engine is enabled to combine the customer data with the display data to generate and provide reports to the brand for changes and controls to be implemented on a near real time basis if needed.

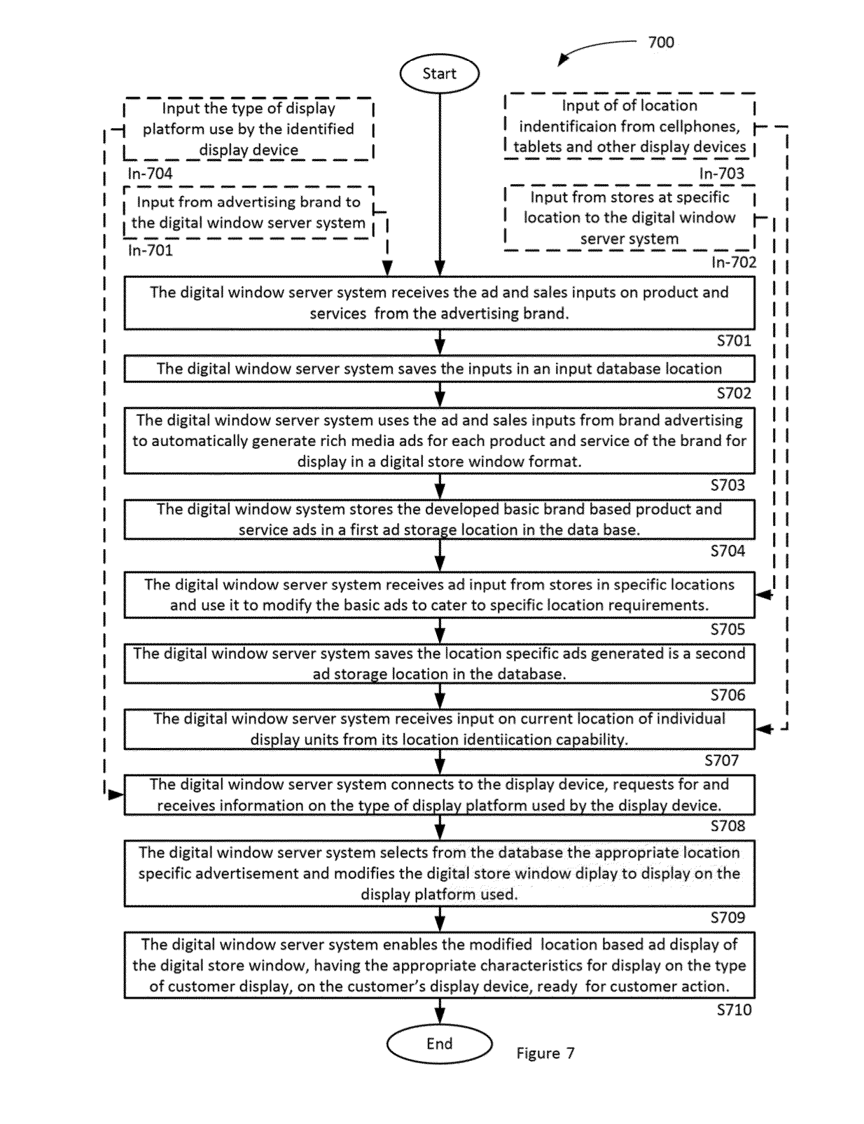

FIG. 7 is a flow chart of one embodiment showing the generation and display of location specific advertisements over the digital store window using the server system. Four sets of inputs are used to generate and modify the dynamic digital store window display. The first input, In-701, to the flow chart is from the brand, which provide information on the product and services of the brand, outlet locations, information on the sales and other incentive schemes available to the branded products, etc. The inputs can be in the form of text, images, videos, HTML widgets or any combination of these.

The second input, In-702, is the input from the local stores that carry the brand products and services which provide additional incentives and vouchers/coupons to entice customers to walk in, the input further include the store address and contact information with product and service availability to enable customers to make in-store purchase decisions from the advertisement details. These inputs also can be in the form of text, images, videos, HTML widgets or any combination of the forms.

The third input, In-703, is input from the display devices that provide the location information on the current location of these devices In-703. The data is estimated from user location elated attributes or collected from the location fixing capability that is already built into the display devices. This data, though coming from the display devices, may be accessed directly by the digital window system or through location tracking entities that access and provide the data depending on the capabilities set up.

The fourth input, In-704, is also from the display device. This input specifies the type of platform viewed on the display device. The platform used can be any of web sites and social media sites on mobile, desktop and other non-mobile display units. The digital window server (server) system collects gets input and information In-701, on brand content requirements from the advertiser. These inputs can of different forms as described previously. S701.

The inputs received are saved in an input database location on the server system for use in generating the digital window based content. S702. The server system uses the input, relating to the brand products and services, from the advertiser to automatically generate rich media content covering the products and services that comply, that are in the correct format for display on the digital store window, with the advertising strategy laid out by the advertiser for the ad campaign. S703. The server system stores this basic content in a first ad storage location in the database for use. S704.

The server system receives additional inputs, in 702, from the store locations that sell products or provide services of the advertiser. These may include additional incentives to the customer in the form of published discounts, vouchers for purchase etc. These inputs are used by the server system to automatically modify the stored basic rich-media ads to generate location/store specific digital store window ads for each product and service being advertised for at each of the specific store locations. S705. These generated ads are stored by the server system in second ad storage location in the database. S706. When an individual customer with a display system is in the vicinity of a store physically or virtually, the server system receives that information either directly from connected display devices in the proximity of the customer or from groups that handle location tracking applications. S707.

The server system then establishes a connection to the display device of the customer, requests for and receives the type and characteristics of the display on the device. S708. The server system then selects from the database the appropriate location specific advertisements, with included store based modifications and store location information, and modifies it to display over the platform used by the display device as a digital store window display. S709.

The server system provides to each mobile display unit the appropriately modified location and store specific advertisement for display as a digital store front display, with the right characteristic for the type of display screen. The customer is then able to see the display on the individual's display device and take the necessary action to search for, get information, make decisions on purchase, and order products advertised on-line with coupons or vouchers, or walk into the store nearby for placing order in-store with available incentives for purchase. S710.

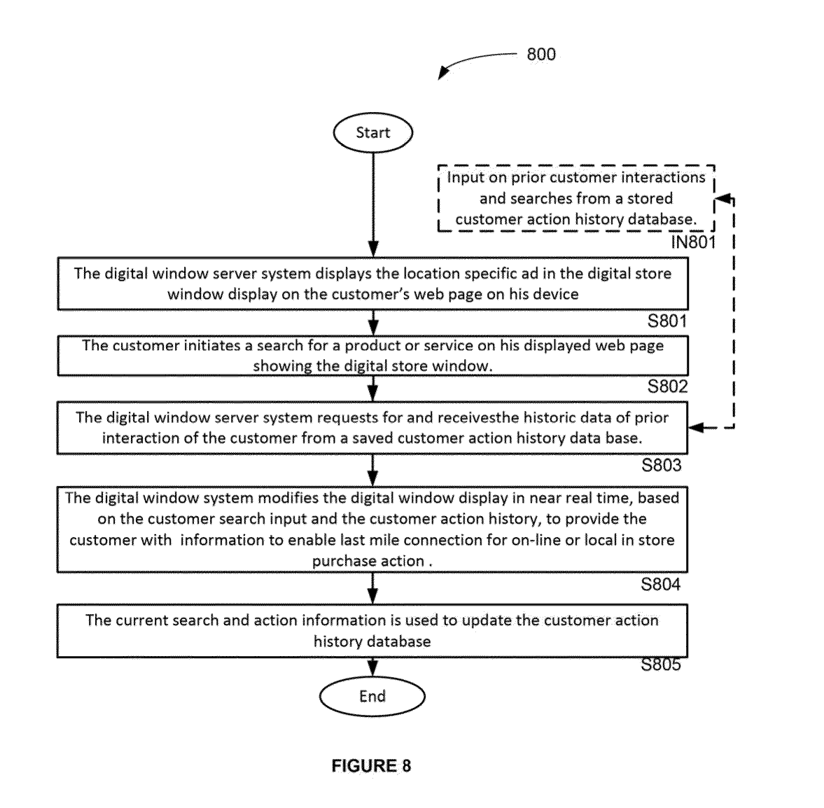

FIG. 8 is a flow chart 800 of one embodiment showing the response to an activity by the customer on the digital store-front display. The advertisements as a store front display is enabled on the customer's display unit in a digital display window. S801. The server system receives input of customer search action on the display. It may be a request for information regarding a product, price, or availability request. S802. The window system requests and receives from a customer history database the history of the previous actions of the customer. S803. The combination of the customer action history and the customer's search action are combined to generate an opportunity projection for the customer. This opportunity projection is used to modify the digital display window on the customer site to provide the customer with information to enable the last mile connection for on-line or in-store walk-in purchase decision. S804. The current search and action information is used to up-date the customer action database. S805.

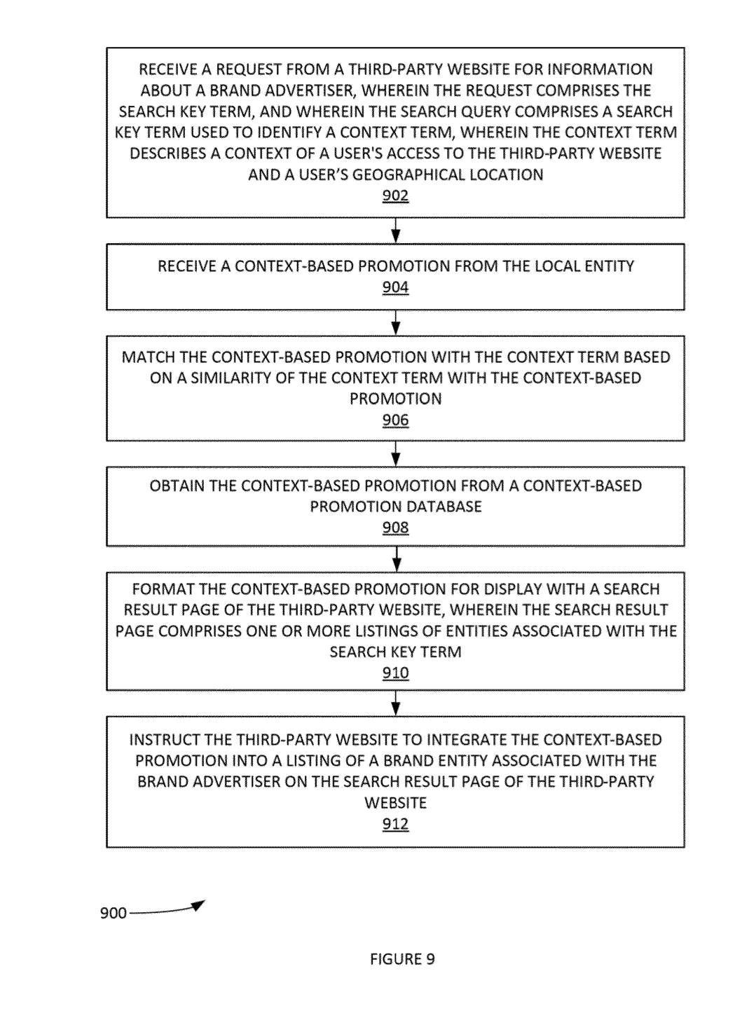

FIG. 9 illustrates an example process 900, according to some embodiments. In step 902, a request from a third-party website for information about a brand promoter (e.g. brand advertiser, brand representative, etc.) can be received. The brand promoter can be an entity that represents a brand of a corporation, person, etc. The third-party website can be an entity can aggregates information about other entities and/or links to said entity's websites. In one example, the third-party website can be a crowd-sourced local business review website and/or mobile application (e.g. Yelp®, etc.). In another example, the third-party website can be an online city guide that provides information about businesses in the categories of dining, entertainment, retail, travel, and professional services (e.g. Citysearch®). In yet another example, the third-party website can be an online social networking website (e.g. Facebook®, Twitter®, LinkedIn®, etc.). In some example, the third-party websites can provide information via a mobile device application. The request can include the search key term, and wherein the search query comprises a search key term used to identify a context term. The context term describes a context of a user's access to the third-party website (e.g. key search terms recently used by the user on a search engine, a user's geographical location, user web browsing history, user demographic information, etc.). In some embodiments, the third-party website can be a type of digital window.

In step 904, a context-based promotion from the local entity can be received. The context-based promotion can be provided by a brand entity. In one example, a library of context-based promotions can be provided by the brand entity. The brand-entity can periodically update the library. Additionally, in some examples, local entities of the brand entity (e.g. a franchise store manager) and/or subsets of the brand entity can modify context-based promotions to be provided to local users. The context-based promotion can include a brand advertisement, brand catalog, brand information, brand-related coupons. etc. The context-based promotion can include localized brand information (e.g. information about a specific store determined to be within a specified distance from a user, etc.). In some examples, the brand entity can receive personalized information about the user (e.g. web browsing history, demographic information, past purchase history, etc.). Accordingly, the can be a personalized, contextual content-based promotion based on real-time dynamic content.

In step 906, the context-based promotion can be matched with the context term based on a similarity of the context term with the context-based promotion. Process 900 can access a database of context-based promotions and/or context-based promotion elements. Process 900 can rank and order the context-based promotions and/or context-based promotion elements based on relevancy to the context term and/or other factors user's location, demographics and/or other personal history). Process 900 can then select the most relevant context-based promotions and/or context-based promotion elements. Accordingly, in step 908 the context-based promotion can be obtained from a context-based promotion database.

In step 910, the context-based promotion can be formatted for display with a search result page (e.g. a listing-detail page) of the third-party website, wherein the search result page comprises one or more listings of entities associated with the search key term. The context-based promotion can include a brand advertisement, brand catalog, brand information, local franchise promotions, etc. The context-based promotion can include localized brand information (e.g. information about a specific store determined to be within a specified distance from a user, etc.). In step 912, the third-party website can be instructed to integrate the context-based promotion into a listing of a brand entity associated with the brand promoter on the search result page of the third-party website. It is noted, that when an entity identifier (e.g. brand promoter, user, local entity, etc.) is used herein, said identifier can be an alias of a computing system utilized to perform the various steps or processes being described. For example, the term ‘user’ can include a mobile device's web browser being utilized by the user to access a crowd-sourced local business review website and/or mobile application. In this way, the various steps of process 900 can be automatically performed.

In one example, the brand promoter can be a local entity such as a local franchise of a brand company represented by the brand promoter. The local status of the local entity vis-á-vis a user utilizing the third-party website can be determined based on to distance between the user and the local entity. For example, it can be determined that both the user (e.g. an alias of the user's computing device, mobile device, etc.) can be in the same city or zip code of the local entity's franchise store.

User location can be determined from a variety of sources (e.g. as determined by GPS, assisted GPS (AGPS), cell tower information, mobile device's Internet-access server, WiFi hotspots, mobile phone number, mobile device's IP Address, etc.). A user's mobile device can be set as a source of the user's current location.

Process 900 can be implemented by a server-side platform. The server-side platform can manage an application programming inter ace (API). The API can receive requests from various third-party entity servers. The requests can before for context-based promotions. The requests can include information about the proper formatting, for the context-based promotion (e.g. a digital store front window). For example, when the third-party entity is to review website, the context-based promotion can be a web-page element for integration into a listing within a web page (e.g. iframe, server-side API, JavaScript code, SDK for to mobile application, etc.). In another, example, the third-party entity may request that the context-based promotion be formatted for integration in a listing displayed in a mobile-device application display of brand listings. In another example, the request may include a notice that an entity associated with the brand a local franchise, a product, etc.) is to be displayed on the review website. In this case, the brand entity can then format information (e.g. an advertisement, announcement, etc.) for display in the review listings and provide said format information to the review website. The third-party entity can provide various display constraint information to the brand promoter.

Server-side platform can aggregate use statistics, quality issues, service issues and the like with respect to process 900. Server-side platform can provide a dashboard that graphically displays this information. Server-side platform can acquire and maintain a list of the local entities associated with a brand (e.g. a list of Starbucks® stores in a region area). Server-side platform can pull in third-party entities that list the list of local entities. Server-side platform can generate instructions for integrating brand and/or local entity context-based promotions into third-party entities websites (and/or other digital methods of distributing reviews such as via mobile device applications).

In one example, a user can perform a Google® search for a washing machine. The Google® search results can include a listing for Yelp®. The user can follow the hyperlink in the listing for Yelp® and land on a Yelp® webpage for BestBuy®. In this example, Yelp® is the third-party website and BestBuy® is the brand promoter. BestBuy® can provide Yelp® a context-based promotion to display on the Yelp® webpage for BestBuy®. BestBuy® can have information about the search key-term ‘washing machine’. This can be used as the context term describes a context of a user's access to Yelp®. Accordingly, a BestBuy® server-side process can automatically generate a context-based promotion that includes information about washing machines (e.g. a washing-machine related offer or promotion). This is an example of a listing being made contextual (e.g. contextual to a user's search). This context-based promotion can be provided to a Yelp® server for integration into the Yelp® webpage for BestBuy®. In some example, a local BestBuy® can include specific information to be integrated into the he Yelp® webpage for BestBuy®. This is an example of a listing being made contextual to a user's location. This example can be modified for when a user utilizes the Yelp® mobile device application to search for a washing machine.

in one example, process 900 can apply machine-learning algorithms to personalize a context-based promotion's content to the user. Accordingly, process 900 can build a model based on inputs (e.g. key search terms recently used by the user on a search engine, user location, user web browsing history, user demographic information, etc.). Process 900 can use the model to make predictions or decisions, rather than following only explicitly programmed instructions. These predications and/or decisions can pertain to a user-specific context-based promotion. Example machine learning techniques, can include, inter alia: artificial neural networks; Bayesian networks; random forests; cluster analysis; vector quantization; Deep Boltzmann machines; Q-learning; deep Boltzmann machines; etc.

### Conclusion

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it will be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A method comprising;
a digital window for a contextual content that is a digital store front window;
a server system for receiving content inputs from brand promoters and local stores;
the server system comprising at least the following;
a processor, a database; a communication interface; and a storage memory;
the server system enabled to automatically venerate location specific rich media displays using the content input from a brand promoter, that ate modified b a content input from a local store of a specific location;
the server system compiling the rich media advertisements for display on t digital store front window;
the digital store front window enabled for displaying the generated rich media content on multiple mobile and non-mobile type display platforms;
the digital store front window further enabled to transmit a generated location specific rich, media advertisements to display units in each specified location for display on then spec die platforms;
the location specific content on the digital store window thereby impacting both on-line purchasing by a first group of customers, and local in-store purchasing by a second group of customers;
wherein the first group of customers is enabled to get information on the product or service, over the digital window, regarding quality, pricing, availability, sales, vouchers, customer reviews of the product, and other characteristics and attributes of importance to enable them to make on-line purchase decisions; and
wherein the second group of customers are enabled to identify the local store with product or service availability, in addition to being enabled to get information on the product or service, over the digital window, regarding quality, pricing, availability, sales, vouchers, customer reviews of the product, and other characteristics and attributes of importance to enable them to walk into the local store and make in-store purchase decisions.

2. The method of claim 1 wherein the server system comprise multiple connected servers.

3. The method of claim 1, wherein the server system comprise multiple servers in the cloud.

4. The method of claim wherein the contextual content comprises content that is related to a user's location or to a user's recent key word in a search query.

5. The method of claim 1, wherein a display unit comprises a mobile device or a non-mobile device.

6. The method of claim 1, wherein the digital store front window comprises a web page element or a mobile-device application display element.

7. A method comprising:
receiving a request from a third-party website for information about a brand promoter, wherein the request comprises a search key term, and wherein the search query comprises a search key term used to identify a context term, wherein the context term describes a context of a user's access to the third-party website and a user's geographical location;
receiving a context-based promo on from the brand promoter;
matching the context-based promotion with the context term based on a similarity of the context term with the context-based promotion;
obtaining the context-based promotion from a context-based promotion database;
formatting the context-based promotion for display with a search result page of the third-party website, wherein the search result page comprises one or more listings of entities associated with the search key term, and
instructing the third-party website to integrate the context-based promotion into listing of a brand entity associated with the brand promoter on the search result page of the third-party website.

8. The method of claim 7:
wherein the brand entity comprises a local entity comprising a local franchise of the brand entity, and
receiving a request from a third-party website for information about a local entity, wherein the local entity is within a geographical distance from a user that provided a search query, wherein the search query comprises a context term, and wherein the request comprises the context term.

9. The method of claim 8 further comprising:
wherein the digital promotion comprises a set of text generated by the local entity, and
instructing the third-party website to integrate the digital promotion into a snippet portion of the listing, of the location entity of the search result page for a specified period of a time of day.

10. The method of claim 9 further comprising:
instructing the third-party website to integrate the digital promotion into a listing of the location entity of the search result page for a specified period of a time of day.

11. The method of claim 7 further comprising:
receiving a promotion content for the digital promotion from the brand entity.

12. The method of claim 7, wherein the third-party website comprises a crowd-sourced local business review website.

13. The method of claim 7, wherein the context-based promotion is formatted into a HyperText Markup Language (HTML) element configured for integration into the search result page of the third-party website.

14. The method of claim 7, wherein the third-party website is formatted for display on a mobile device's web browser or a mobile device's application.

15. A server system for advertisement publishing computing platform comprising:
a processor configured to execute instructions;
a memory containing instructions when executed on the processor, causes the processor to perform operations that:
receive a request from a third-party website for information about a brand advertiser, wherein the request comprises the search key term, and wherein the search query comprises a search key term used to identify a context term, wherein the context term describes a context of a user's access to the third-party website and a user's geographical location;
receive a context-based promotion from the brand advertiser;
match the context-based promotion with the context term based on a similarity of the context term with the context-based promotion;
obtain the context-based promotion from a context-based promotion database;
format the context-based promotion for display with a search result page of the third-party website, wherein the search result page comprises one or more listings of entities associated with the search key term; and
instruct the third-party website to integrate the context-based promotion into a listing of a brand entity associated with the brand advertiser on the search result page of the third-party website.

16. The server system of claim 15, wherein the brand entity comprises a local entity comprising a local franchise of the brand entity, and wherein memory containing instructions when executed on the processor, causes the processor to perform operations that:
receive a request from a third-party website for information about a local entity, wherein the local entity is within a geographical distance from a user that provided a search query, wherein the search query comprises a context term, and wherein the request comprises the context term.
wherein the digital promotion comprises a set of text generated by the local entity, and
instructing the third-party website to integrate the digital promotion into a snippet portion of the listing of the location entity of the search result page for a specified period of a time of day.

17. The server system of claim 16, wherein memory containing instructions when executed on the processor, causes the processor to perform operations that:
instruct the third-party website to integrate the digital promotion into a listing of the location entity of the search result page for a specified period of a time of day.

18. The server system of claim 15, wherein memory containing instructions when executed on the processor, causes the processor to perform operations that:
receive a promotion content for the digital promotion from the brand entity.

19. The server system of claim 15, wherein the third-party website comprises a crowd sourced local business review website, and wherein the search result page comprises a listing-detail page.

20. The server system of claim 15, wherein the user's geographical location is determined from a user's mobile device location.
